(19) United States
(12) Patent Application Publication
(10) Pub. No.: US 2008/0026189 A1
(43) Pub. Date: Jan. 31, 2008

(54) Thin key structure for generating dazzling light

(76) Inventors: Chun-Wei Lin, Luo Tung Jen (TW); Ching-Chang Hsieh, Nantou City (TW); Chien-Chang Chen, Yujing Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/493,548

(22) Filed: Jul. 27, 2006

(51) Int. Cl. B32B 9/04; B32B 15/04; B32B 27/00; B32B 25/00

(52) U.S. Cl. 428/195.1; 428/332; 428/411.1; 428/457

(57) ABSTRACT

A thin key structure for generating dazzling light includes a thin film layer, a protective layer, a stripe layer, and a flexible layer. The thin film layer has a thickness is between 0.05˜0.4 mm. The protective layer is disposed on a top side of the thin film layer. The stripe layer is disposed on a bottom side of the thin film layer. The flexible layer is disposed on a bottom side of the stripe layer. The thin key structure is made of a complex material that has different materials and color, and is formed integratedly via a way of an extrusion molding. Hence, the appearance of the key structure has a multi-layer variation and has a good reliability.

### BACKGROUND OF THE INVENTION

1. Field of The Invention

The present invention relates to a thin key structure, and particularly relates to a thin key structure having a dazzling light generating function and formed integratedly via an extrusion molding.

2. Description of the Related Art

With the coming age of information technologies and the advance of network technologies, mobiles (or cell phones) grow to be one of the most widespread communication tools. Cell phones become increasingly popular for consumers due to their attribute of small in sizes, portability, versatile in functions, and most importantly, the steadily decreasing price. In terms of purchasing cell phones, the appearances and functions are the determining factors for majority buyers. Hence, the market responds to this trend by placing multi-functional, new and good-looking cell phones on the shelf.

The variation of cell phone appearances are mostly based on the designs and developments of keypads and covers. In order to express the quality and the esthetics of the appearances of keypad module, it is necessary for them to go through additional and complicated manufacturing process. For example a keypad module that can produce dazzling light, the manufacturing way of the dazzling light keypad is as follows: to form various of different stripes on a thin metal sheet so that the keypad module can be radiated via the metal sheet. However, such way of dazzling the keypad module still has the following drawbacks:

1. Because the metal sheet is made of metal material, the cost would be increased.

2. Cellular antenna is usually used to receive high frequency signals. Hence, the use of metal sheet would limit the electronic characteristics of the cellular antenna.

3. The process of forming various of different stripes on a metal sheet is more difficult and complicated.

Another commonly known way of dazzling the keypad is to form various of different stripes on a thin plastic sheet. Nevertheless, there are other weaknesses of doing so. They are as follows.

1. The plastic sheets are made from injection molding and the thickness of these plastic sheets needs to be extremely thin. Due to this requirement, the acceptable quality level of yielded plastic sheet would be decreased.

2. The life expectancy of these injection-molding molds would decrease due to the manufacturing of such thin plastic sheet. Consequently, not only the cost of manufacturing would increase, but also extend the time and procedure of manufacturing the keypad module.

3. The thickness of the plastic sheets, utilizing current technologies with injection molding, is around about 4 mm and above. Thus, the thickness would be limited and practically unfeasible.

4. Injection-molding would also limit the number of color used, the depth of stripes and the level of complexities of plastic sheets. As a result, the plastic sheets manufactured by injection molding cannot change its color, has a shallow stripe, and cannot produce complicated stripes.

5. The most commonly used material for injection molding is either acrylics or Propylene Carbonate. However, the disadvantages of acrylic materials are poor in transparency and fragile when the hardness is high, that is, easily been cracked. Propylene Carbonate, on the other hand, has the drawback of lack in wear-resisting, i.e. easily been scratched.

### SUMMARY OF THE INVENTION

The present invention provides a thin key structure for generating dazzling light. The thin key structure is made of a complex material that has different materials and color, and is formed integratedly via a way of an extrusion molding. Hence, the appearance of the key structure has a multi-layer variation and has a good reliability. The present invention does not need another attachment process, and can reduce the using numbers of mold and tool. In other words, the thin key structure of the present invention can be manufactured via an apparatus only. Hence, the present invention can reduce cost.

One aspect of the invention is a thin key structure for generating dazzling light, comprising: a thin film layer, a protective layer, a stripe layer, and a flexible layer. The thin film layer has a thickness is between 0.05˜0.4 mm. The protective layer is disposed on a top side of the thin film layer. The stripe layer is disposed on a bottom side of the thin film layer. The flexible layer is disposed on a bottom side of the stripe layer.

Another aspect of the invention is a thin key structure for generating dazzling light, comprising: a thin film layer, a plurality of projected bodies, a stripe layer, and a flexible layer. The thin film layer has a thickness is between 0.05˜0.4 mm. The projected bodies are disposed on a top side of the thin film layer respectively. The stripe layer is disposed on a bottom side of the thin film layer. The flexible layer is disposed on a bottom side of the stripe layer.

It is to be understood that both the foregoing general description and the following detailed description are exemplary, and are intended to provide further explanation of the invention as claimed. Other advantages and features. of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is cross-sectional, schematic view of a thin key structure for generating dazzling light according to the first embodiment of the present invention;

FIG. 2 is cross-sectional, schematic view of a thin key structure for generating dazzling light according to the second embodiment of the present invention;

FIG. 3 is cross-sectional, schematic view of a thin key structure for generating dazzling light according to the third embodiment of the present invention; and

FIG. 4 is cross-sectional, schematic view of a thin key structure for generating dazzling light according to the fourth embodiment of the present invention.

### DETAILED DESCRIPTION OF PREFERRED EMBODIMENTS

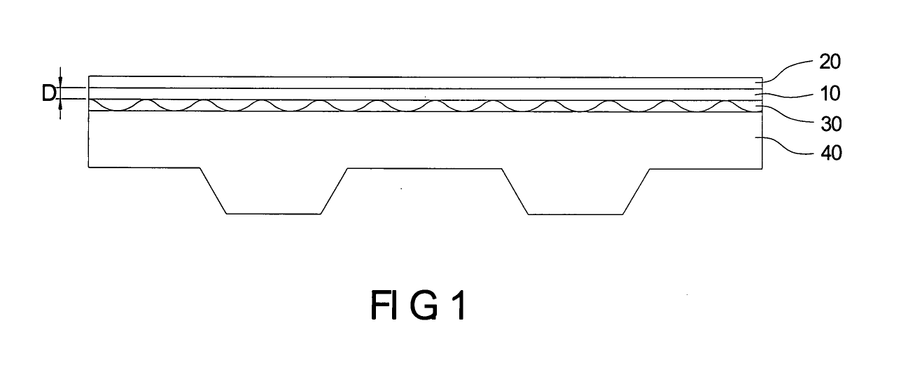

FIG. 1 shows a cross-sectional, schematic view of a thin key structure for generating dazzling light according to the first embodiment of the present invention. The first embodiment of the present invention provides a thin key structure for generating dazzling light, comprising: a thin film layer 10, a protective layer 20, a stripe layer 30, and a flexible layer 40.

The thin film layer 10 can be a plastic sheet or a plastic film that is made of a transparent plastic material. The thin film layer 10 is a printing film layer that has a plurality of patterns, symbols, words or numerals formed thereon. Moreover, the thin film layer 10 has a thickness D is between 0.05˜0.4 mm.

Furthermore, the protective layer 20 is disposed on a top side of the thin film layer 10, and the protective layer 20 can be a wear-resistant resin film or printing ink film. Moreover, the stripe layer 30 is disposed on a bottom side of the thin film layer 10, and the stripe layer 30 has a plurality of regular or irregular stripes formed thereon. In addition, the flexible layer 40 is disposed on a bottom side of the stripe layer 30, and the flexible layer 40 can be made of a flexible rubber material or flexible plastic material.

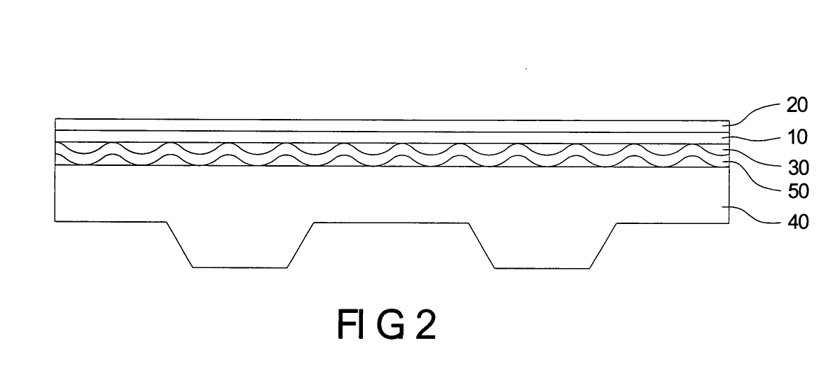

FIG. 2 shows a cross-sectional, schematic view of a thin key structure for generating dazzling light according to the second embodiment of the present invention. The difference between the second embodiment and the first embodiment is that the second embodiment further comprises a metal layer 50 disposed between the stripe layer 30 and the flexible layer 40. Hence, the metal the metal layer 50 can express the quality of the appearances of the key structure according to the second embodiment of the present invention.

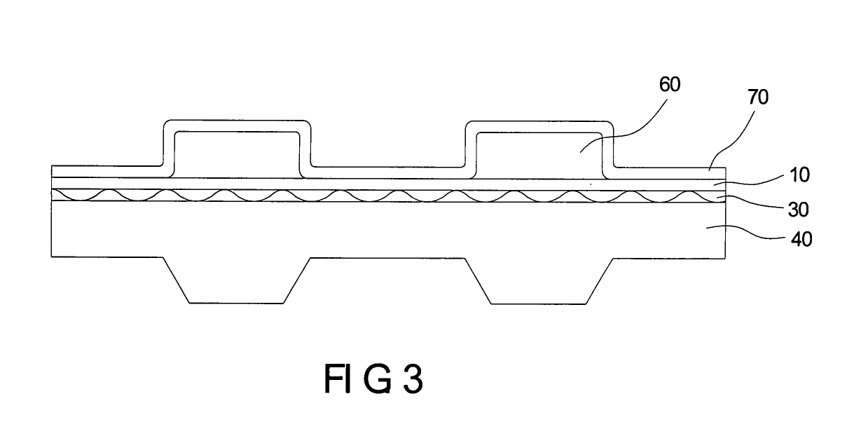

FIG. 3 shows a cross-sectional, schematic view of a thin key structure for generating dazzling light according to the third embodiment of the present invention. The third embodiment of the present invention provides a thin key structure for generating dazzling light, comprising: a thin film layer 10, a plurality of projected bodies 60, a protective layer 70, a stripe layer 30, and a flexible layer 40.

The projected bodies 60 can be a plurality of patterns, symbols, words or numerals respectively, and the projected bodies 60 are disposed on a top side of the thin film layer 10 respectively. Moreover, the protective layer 70 is disposed on the thin film layer 10 and the projected bodies 60, and the protective layer 70 can be a wear-resistant resin film or printing ink film. The stripe layer 30 is disposed on a bottom side of the thin film layer 10, and the flexible layer 40 is disposed on a bottom side of the stripe layer 30.

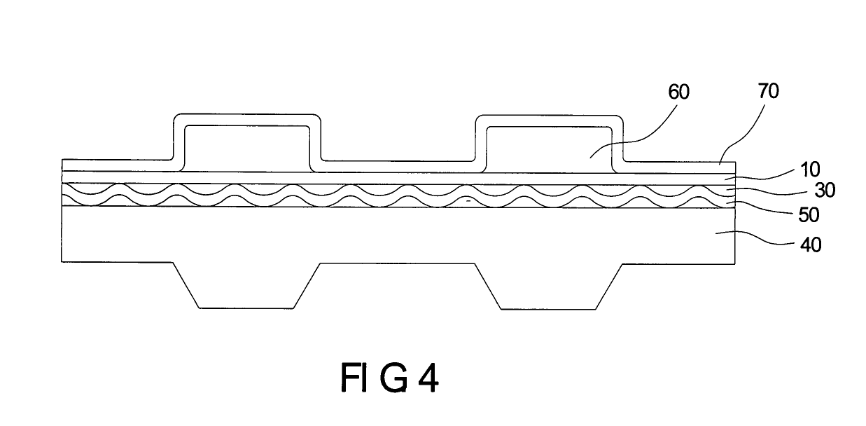

FIG. 4 shows a cross-sectional, schematic view of a thin key structure for generating dazzling light according to the fourth embodiment of the present invention. The difference between the fourth embodiment and the third embodiment is that the fourth embodiment further comprises a metal layer 50 disposed between the stripe layer 30 and the flexible layer 40. Hence, the metal the metal layer 50 can express the quality of the appearances of the key structure according to the fourth embodiment of the present invention.

In conclusion, the thin key structure is made of a complex material that has different materials and color, and is formed integratedly via a way of an extrusion molding. Hence, the appearance of the key structure has a multi-layer variation and has a good reliability. The present invention does not need another attachment process, and can reduce the using numbers of mold and tool. In other words, the thin key structure of the present invention can be manufactured via an apparatus only. Hence, the present invention can reduce cost.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A thin key structure for generating dazzling light, comprising:
a thin film layer;
a protective layer disposed on a top side of the thin film layer;
a stripe layer disposed on a bottom side of the thin film layer; and
a flexible layer disposed on a bottom side of the stripe layer.

2. The thin key structure as claimed in claim 1, wherein the thin film layer has a thickness is between 0.05˜0.4 mm.

3. The thin key structure as claimed in claim 1, wherein the thin film layer is a plastic sheet or a plastic film that is made of a transparent plastic material.

4. The thin key structure as claimed in claim 1, wherein the thin film layer is a printing film layer that has a plurality of patterns, symbols, words or numerals formed thereon.

5. The thin key structure as claimed in claim 1, wherein the protective layer is a wear-resistant resin film or printing ink film.

6. The thin key structure as claimed in claim 1, wherein the stripe layer has a plurality of regular or irregular stripes formed thereon.

7. The thin key structure as claimed in claim 1, wherein the flexible layer is made of a flexible rubber material or flexible plastic material.

8. The thin key structure as claimed in claim 1, further comprising a metal layer disposed between the stripe layer and the flexible layer.

9. A thin key structure for generating dazzling light, comprising:
a thin film layer;
a plurality of projected bodies disposed on a top side of the thin film layer respectively;
a stripe layer disposed on a bottom side of the thin film layer; and
a flexible layer disposed on a bottom side of the stripe layer.

10. The thin key structure as claimed in claim 9, wherein the projected bodies are a plurality of patterns, symbols, words or numerals respectively.

11. The thin key structure as claimed in claim 9, further comprising a protective layer disposed on the thin film layer and the projected bodies.

12. The thin key structure as claimed in claim 11, wherein the protective layer is a wear-resistant resin film or printing ink film.

13. The thin key structure as claimed in claim 9, further comprising a metal layer disposed between the stripe layer and the flexible layer.
